(19) United States
(12) Patent Application Publication
(10) Pub. No.: US 2017/0222406 A1
(43) Pub. Date: Aug. 3, 2017

(54) RHODIUM ALLOYS

(71) Applicant: JOHNSON MATTHEY PUBLIC LIMITED COMPANY, London (GB)

(72) Inventors: Duncan Roy COUPLAND, Hertfordshire (GB); Robert Brinley MCGRATH, Hertfordshire (GB)

(21) Appl. No.: 15/500,566

(22) PCT Filed: Jul. 31, 2015
(86) PCT No.: PCT/GB2015/052236

§ 371 Date: Jan. 31, 2017

(30) Foreign Application Priority Data
Aug. 1, 2014 (GB) 1413722.8

(51) Int. Cl. H01T 13/39; C22C 5/04

(52) U.S. Cl. CPC H01T 13/39; C22C 5/04

(57) ABSTRACT

Disclosed is an electrode including a rhodium alloy, wherein the rhodium alloy includes rhodium and nickel. The alloy includes a greater quantity of rhodium as compared to any other individual element of the alloy.

### FIELD OF THE INVENTION

The present invention relates to rhodium alloys comprising nickel, and to the use of the alloys, in particular, as spark ignition electrodes.

### BACKGROUND

US2007/194681 (to Denso Corporation) describes a spark plug for an internal combustion engine wherein at least one of the centre or ground electrodes comprises rhodium and an additive 0.3% to 2.5% by weight of one or more selected from earth rare elements, IVA elements, and VA elements, as listed in the periodic table of elements. US2007/194681 does not describe alloys comprising nickel or a second platinum group metal (PGM).

EP2738892A (to NGK Sparkplug Co. Ltd.) describes a spark plug which includes a tip. The tip of the spark plug contains an element group M (M consists of at least one species of Pt or Rh) in an amount of 3 mass % to 35 mass %, and an element group L (L consists of at least one species of Ir, Ru, and Pt) in an amount of 0 mass % to 15 mass %. The total amount of the element group M and the element group L is 3 mass % to 35 mass %, and the total amount of Ni, the element group M, and the element group L is at least 94 mass %. The amount of Ni, therefore, is 59 mass % to 97 mass %.

J. R. Handley (Platinum Metals Review, 1989, 33, (2), 64-72 and 1990, 34, (4), 192-204) describes binary, ternary and complex rhodium alloys. Neither journal article describes the alloys of the present invention nor the use of rhodium alloys as spark ignition electrodes.

### SUMMARY OF THE INVENTION

The present inventors have developed rhodium alloys which have enhanced resistances to wear, such as those arising from exposure to sparks. In certain embodiments, the alloys are also easy to manufacture. In certain embodiments, the alloys demonstrate good to very good formability i.e. they are able to undergo plastic deformation without being significantly damaged through fracturing or tearing. In certain embodiments, the alloys exhibit the ability to be welded.

In one aspect, therefore, the present invention provides a spark ignition electrode comprising a rhodium alloy, wherein the rhodium alloy comprises:

i) rhodium; and

ii) nickel;

wherein the alloy comprises a greater quantity of rhodium as compared to any other individual element of the alloy.

In another aspect, the invention provides a spark plug comprising an electrode as defined herein.

In yet another aspect, the invention provides the use of the rhodium alloys as defined herein in an electrode or spark plug.

In another aspect, the invention provides a rhodium alloy comprising:

i) rhodium;

ii) nickel; and

iii) one or more elements selected from the group consisting of yttrium, zirconium and samarium;

wherein the alloy comprises a greater quantity of rhodium as compared to any other individual element of the alloy.

### DETAILED DESCRIPTION

As described above, the present invention provides a spark ignition electrode comprising a rhodium alloy, wherein the rhodium alloy comprises:

i) rhodium; and

ii) nickel; and

wherein the alloy comprises a greater quantity of rhodium as compared to any other individual element of the alloy.

It will be understood that whilst the amounts of each element are given assuming that the base alloy is pure rhodium, in practical terms, the rhodium and the alloying elements may contain impurities at levels which would be normally expected for such metals.

Rhodium is a platinum group metal (PGM) which exhibits high melting and boiling points, as well as excellent oxidation and corrosion resistances. Rhodium also displays a low vapour pressure and high thermal conductivity which, when allied with the above properties, suit its potential for use as a spark ignition electrode. However, rhodium metal itself cannot be adequately exploited as a spark ignition electrode due to its relatively poor mechanical properties and relatively low density. The present inventors have found that the properties of rhodium which make it a poor spark ignition electrode can be improved by selective alloying. In this respect, the rhodium alloy as described herein comprises rhodium as the main element in the alloy. Rhodium therefore is present in the alloy in the greatest quantity (as expressed as a percentage by weight (wt %)) as compared to any other individual element of the alloy (also expressed as a percentage by weight (wt %)). Any other element of the alloy is individually a minor element as compared to rhodium.

While each element or a combination of elements in the alloy may be expressed as a range, the total wt % of the rhodium alloy adds up to 100 wt %.

The rhodium alloy may comprise about ≧30 wt % of rhodium, such as about ≧40 wt % of rhodium, such as about ≧50 wt % of rhodium. In one embodiment, the rhodium alloy may comprise about 30 to 99 wt % of rhodium, such as about 30 to about 95 wt % of rhodium, for example about about 40 to about 90 wt % of rhodium. In one preferred embodiment, the rhodium alloy comprises about 40 to about 99 wt % of rhodium, such as about 45 to about 95 wt %, for example about 47 to about 90 wt %.

The rhodium may be alloyed with at least one of iridium, platinum or palladium. In this respect, up to about 49.99 wt % (e.g. about 0.01 to about 49.99 wt %) each of one or more elements selected from the group consisting of iridium, platinum and palladium may be present. Iridium, platinum and palladium have excellent solid solubilities with rhodium and, as such, are suitable as alloying elements in preparing rhodium alloys. In one embodiment, the rhodium alloy may comprise up to about 49.99 wt % of iridium, such as 0 to about 40 wt %, for instance about 0.01 to about 25 wt %, for example about 0.1 to about 20 wt % or about 0.5 to about 15 wt % of iridium. In another embodiment, the rhodium alloy may comprise up to about 49.99 wt % of platinum, such as 0 to about 40 wt %, for instance about 0.01 to about 25 wt %, for example about 0.1 to about 20 wt %. In another embodiment, the rhodium alloy may comprise up to about 49.99 wt % of palladium, such as 0 to about 40 wt %, for instance about 0.01 to about 25 wt %, for example about 0.1 to about 20 wt %.

When present in the rhodium alloy, ruthenium may be present in up to about 35 wt %. In this regard, it is generally desirable to limit the quantity of ruthenium to about ≦35 wt % as the solid solubility of ruthenium in rhodium is good within this range whilst retaining a single phase solid solution. Ruthenium is suitable as an alloying element as its corrosion resistance is similar to that of iridium. The presence of ruthenium (and/or iridium), therefore, improves the corrosion resistance of the rhodium alloy as compared to rhodium metal alone. Ruthenium also exhibits high melting/boiling points, high atomic weight and high thermal conductivity, all characteristics which are favourable for resistance to spark erosion. The rhodium alloy may comprise no ruthenium i.e. 0 wt % ruthenium. Alternatively, the rhodium alloy may comprise about 0.01 to about 35 wt % ruthenium, such as about 0.1 to about 34 wt %, for instance about 1 to about 32 wt %, for example about 5 to about 31 wt %.

The rhodium alloy may comprise about 0.01 to about 49.99 wt % of nickel. Nickel has an excellent solid solubility in rhodium and is suitable as an alloying element in preparing rhodium alloys. The presence of nickel offers an improved compatibility for any welding process used to join a sparking tip with the body of an ignition electrode. In addition, visual observation made during testing suggests that the power of the spark emitted by the electrode is increased as electrical resistivity of the alloy is increased by the addition of nickel. The rhodium alloy may comprise about 1 to about 48 wt % of nickel, such as about 5 to about 45 wt %, e.g. about 6 to about 45.5 wt %, for instance about 7 to about 44 wt %, for example about 8 to about 43 wt %.

The rhodium alloy may also comprise up to about 5 wt % (such as about 0 to about 5 wt %) each of any one of more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium, tungsten and/or molybdenum e.g. chromium and/or tungsten. Without wishing to be bound by theory, it is believed that the inclusion of these elements may ductilise the alloys i.e. make the alloys more tolerant to deformation and ease of manufacture. The rhodium alloy may comprise ≧ about 0.01 wt %, such as, ≧ about 0.05 wt %, about 0.1 wt %, ≧ about 0.15 wt % or ≧ about 0.2 wt % each of the elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten. The rhodium alloy may comprise ≦ about 4.5 wt %, such as ≦ about 4.0 wt %, ≦ about 3.5 wt %, ≦ about 3.0 wt %, about 2.5 wt %, ≦ about 2.0 wt %, ≦ about 1.5 wt %, ≦ about 1.0 wt %, ≦ about 0.5 wt %, ≦ about 0.4 wt % or ≦ about 0.3 wt % each of the elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten. In one embodiment, about 0.01 to about 5 wt % each may be present, such as about 0.05 to about 2.5 wt %, for example, about 0.1 to about 1.0 wt %. When chromium is present, it may be present in 0 to about 5 wt %, such as about 2.5 to about 5 wt %, e.g. about 3 to about 5 wt % or 0 to about 1 wt %, such as about about 0.2 wt %. When tungsten is present, it may be present in about 0.1 to about 0.5 wt %, such as about 0.1 to about 0.3 wt %.

The rhodium alloy may comprise one or more elements selected from the group consisting of yttrium, zirconium and samarium, preferably zirconium. Without wishing to be bound by theory, it is believed that the inclusion of these elements may ductilise the alloys as described above. It is also believed that the elements (in particular zirconium) may hinder dislocation movement through grain boundaries (i.e. the boundaries between crystal lattices at different orientations) and hence limit or slow grain growth. Grain growth therefore appears to be reduced at temperature ensuring a fine grain structure is retained. The rhodium alloy may comprise about 0.01 to about 1 wt % (such as about 0.01 to about 0.50 wt %) each of any one or more elements selected from the group consisting of yttrium, zirconium and samarium. The rhodium alloy may comprise ≧ about 0.015 wt %, ≧ about 0.02 wt %, ≧ about 0.025 wt % or ≧ about 0.030 wt % each of any one or more elements selected from the group consisting of yttrium, zirconium and samarium. The rhodium alloy may comprise ≦ about 0.45 wt %, ≦ about 0.40 wt %, ≦ about 0.35 wt %, ≦ about 0.30 wt %, ≦ about 0.25 wt %, ≦ about 0.20 wt %, ≦ about 0.15 wt %, ≦ about 0.10 wt %, ≦ about 0.05 wt % or ≦ about 0.04 wt % each of any one or more elements selected from the group consisting of yttrium, zirconium and samarium.

In one embodiment, the rhodium alloy may comprise about 0.01 to about 0.50 wt % of zirconium. The rhodium alloy may comprise ≧ about 0.015 wt %, ≧ about 0.02 wt %, ≧ about 0.025 wt % or ≧ about 0.030 wt % of zirconium. The rhodium alloy may comprise ≦ about 0.45 wt %, ≦ about 0.40 wt %, ≦ about 0.35 wt %, ≦ about 0.30 wt %, ≦ about 0.25 wt %, ≦ about 0.20 wt %, ≦ about 0.15 wt %, ≦ about 0.10 wt %, ≦ about 0.05 wt % or ≦ about 0.04 wt % of zirconium.

In another embodiment, the rhodium alloy may comprise about 0.01 to about 0.50 wt % of yttrium. The rhodium alloy may comprise ≧ about 0.015 wt %, ≧ about 0.02 wt %, ≧ about 0.025 wt % or ≧ about 0.030 wt % of yttrium. The rhodium alloy may comprise ≦ about 0.45 wt %, ≦ about 0.40 wt %, ≦ about 0.35 wt %, ≦ about 0.30 wt %, ≦ about 0.25 wt %, ≦ about 0.20 wt %, ≦ about 0.15 wt %, ≦ about 0.10 wt %, ≦ about 0.05 wt % or ≦ about 0.04 wt % of yttrium.

In yet another embodiment, the rhodium alloy may comprise about 0.01 to about 0.50 wt % of samarium. The rhodium alloy may comprise ≧ about 0.015 wt %, ≧ about 0.02 wt %, ≧ about 0.025 wt % or ≧ about 0.030 wt % of samarium. The rhodium alloy may comprise ≦ about 0.45 wt %, ≦ about 0.40 wt %, ≦ about 0.35 wt %, ≦ about 0.30 wt %, ≦ about 0.25 wt %, ≦ about 0.20 wt %, ≦ about 0.15 wt %, ≦ about 0.10 wt %, ≦ about 0.05 wt % or ≦ about 0.04 wt % of samarium.

It will be appreciated that elemental yttrium, zirconium and/or samarium is utilised and not e.g. oxides of yttrium, zirconium and/or samarium. In this respect, the oxides are typically added to an alloy which has already been prepared and is mechanically mixed with it. This is in contrast to elemental yttrium, zirconium and/or samarium which are dissolved in the continuous solution formed during the alloy's synthesis. Yttrium, zirconium and/or samarium, therefore, are alloying constituents.

In one preferred embodiment, the rhodium alloy may comprise about 0.02 to about 0.20 wt % each of any one or more elements selected from the group consisting of yttrium, zirconium and samarium. In another preferred embodiment, the rhodium alloy may comprise ≧ about 0.03 wt % each of any one or more elements selected from the group consisting of yttrium, zirconium and samarium, such as about ≧0.04 wt %. In yet another preferred embodiment, the rhodium alloy may comprise about ≦0.175 wt % of any one or more elements selected from the group consisting of yttrium, zirconium and samarium, such as about ≦0.15 wt %, for example, about ≦0.125 wt % or ≦0.1 wt %

In one embodiment, the rhodium alloy comprises:
a) about 70 wt % or more of rhodium, such as about 75 wt %;
b) 0 wt % each of any one or more elements selected from the group consisting of iridium, platinum and palladium;
c) 0 wt % of ruthenium;
d) about 0.01 to about 35 wt % of nickel, e.g. about 0.01 to about 25 wt %;
e) up to about 5 wt % each of any one of more elements selected from the group consisting of niobium, tantalum, titanium, chromium, molybdenum, cobalt, rhenium, vanadium, aluminium, hafnium and tungsten; and
f) optionally about 0.01 to about 0.50 wt % each of any one or more elements selected from the group consisting of yttrium, zirconium and samarium; and
wherein the total wt % of the rhodium alloy adds up to 100 wt %.

In one preferred embodiment, the rhodium alloy may comprise about ≧72 wt % of rhodium, for instance ≧76 wt % for example about 77 wt %, such as about ≧78 wt % or about ≧79 wt %. In another preferred embodiment, the rhodium alloy may comprise about ≦94 wt % of rhodium, for example about ≦93 wt %, such as about ≦92 wt % or about ≦91 wt %. In one preferred embodiment, the rhodium alloy comprises about 80 wt % of rhodium. In another preferred embodiment, the rhodium alloy comprises about 90 wt % of rhodium.

In one preferred embodiment, the rhodium alloy comprises about 10 to about 35 wt % of nickel, such as about 15 to about 25 wt %. In one preferred embodiment, the rhodium alloy may comprise about ≧16 wt % of nickel, for example about ≧17 wt %, such as about ≧18 wt % or about ≧19 wt %. In another preferred embodiment, the rhodium alloy may comprise about ≦35 wt % of nickel, for example about ≦34 wt %, such as about ≦33 wt %, about ≦32 wt % or about ≦31 wt %. In another preferred embodiment, the rhodium alloy may comprise about ≦24 wt % of nickel, for example about ≦23 wt %, such as about ≦22 wt %, about ≦21 wt % or about ≦20 wt %. In one particularly preferred embodiment, the rhodium alloy comprises about 19.86 wt % nickel. In one particularly preferred embodiment, the rhodium alloy comprises about 20 wt % nickel. In one particularly preferred embodiment, the rhodium alloy comprises about 30.5 wt % nickel.

In one preferred embodiment, the rhodium alloy may comprise about 0.01 to about 5 wt % of niobium. In another preferred embodiment, the rhodium alloy may comprise about 0.01 to about 5 wt % of tantalum. In yet another preferred embodiment, the rhodium alloy may comprise about 0.01 to about 5 wt % of titanium. In another preferred embodiment, the rhodium alloy may comprise about 0.01 to about 5 wt % of chromium. In yet another preferred embodiment, the rhodium alloy may comprise about 0.01 to about 5 wt % of molybdenum. In another preferred embodiment, the rhodium alloy may comprise about 0.01 to about 5 wt % of cobalt. In yet another preferred embodiment, the rhodium alloy may comprise about 0.01 to about 5 wt % of rhenium. In another preferred embodiment, the rhodium alloy may comprise about 0.01 to about 5 wt % of vanadium. In yet another preferred embodiment, the rhodium alloy may comprise about 0.01 to about 5 wt % of aluminium. In another preferred embodiment, the rhodium alloy may comprise about 0.01 to about 5 wt % of hafnium. In yet another preferred embodiment, the rhodium alloy may comprise about 0.01 to about 5 wt % of tungsten. When the rhodium alloy comprises tungsten, the tungsten may be present in about 0.05 to about 2.5 wt %, such as about 0.06 to about 1.5 wt %, for example, about 0.07 to about 1 wt % e.g. about 0.1 to about 0.3 wt %.

In one preferred embodiment, the rhodium alloy comprises about 0.01 to about 5 wt % each of any one or more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium and/or tungsten. The rhodium alloy may comprise about ≧0.025 wt % each of any one or more elements selected from the group consisting of niobium, tantalum, titanium, chromium, molybdenum, cobalt, rhenium, vanadium, aluminium, hafnium and tungsten, for example about ≧0.05 wt %, such as about ≧0.075 wt % or about ≧0.10 wt %. The rhodium alloy may comprise about ≦5.0 wt % each of any one or more elements selected from the group consisting of niobium, tantalum, titanium, chromium, molybdenum, cobalt, rhenium, vanadium, aluminium, hafnium and tungsten, for instance about ≦2.50 wt %, for example about ≦2.00 wt %, such as about ≦1.50 wt % or about ≦1.00 wt %. In one particularly preferred embodiment, the rhodium alloy comprises about 2.5 wt % of molybdenum. In another particularly preferred embodiment, the rhodium alloy comprises about 3.4 wt % or about 5.0 wt % of chromium. In another particularly preferred embodiment, the rhodium alloy comprises about 3.0 wt % of aluminium.

In one embodiment, the rhodium alloy does not comprise zirconium, yttrium or samarium.

In another embodiment, the rhodium alloy may comprise about 0.01 to about 0.50 wt % of zirconium.

In another preferred embodiment, the rhodium alloy may comprise about 0.01 to about 0.50 wt % of yttrium. In yet another preferred embodiment, the rhodium alloy may comprise about 0.01 to about 0.50 wt % of samarium.

In one preferred embodiment, the rhodium alloy may comprise about 0.02 to about 0.20 wt % each of any one or more elements selected from the group consisting of yttrium, zirconium and samarium. In another preferred embodiment, the rhodium alloy may comprise about ≧0.03 wt % each of any one or more elements selected from the group consisting of yttrium, zirconium and samarium, such as about ≧0.04 wt %. In yet another preferred embodiment, the rhodium alloy may comprise about ≦0.175 wt % each of any one or more elements selected from the group consisting of yttrium, zirconium and samarium, such as about ≦0.15 wt %, for example, about ≦0.125 wt %.

In one embodiment, the rhodium alloy comprises:
a) about 50 to about 95 wt % or more of rhodium;
b) up to about 25 wt % each of any one or more elements selected from the group consisting of iridium, platinum and palladium;
c) up to about 35 wt % of ruthenium;
d) about 0.01 to about 49.99 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
f) optionally about 0.01 to about 0.50 wt % each of any one or more elements selected from the group consisting of yttrium, zirconium and samarium;
wherein the rhodium alloy comprises at least one of iridium, platinum, palladium or ruthenium; and
wherein the total wt % of the rhodium alloy adds up to 100 wt %.

In one preferred embodiment, the rhodium alloy may comprise about ≧51 wt % of rhodium, for example about ≧52 wt %, such as about ≧53 wt %, about ≧54 wt % or about ≧55 wt %. In another preferred embodiment, the rhodium alloy may comprise about ≦80 wt % of rhodium, for example about ≦79 wt %, such as about ≦78 wt %, about ≦77 wt %, about ≦76 wt % or about ≦75 wt %. In one particularly preferred embodiment, the rhodium alloy comprises about 55 wt % rhodium. In another particularly preferred embodiment, the rhodium alloy comprises about 74 wt % rhodium. In yet another particularly preferred embodiment, the rhodium alloy comprises about 75 wt % rhodium. In another particularly preferred embodiment, the rhodium alloy comprises about 65 wt % rhodium. In yet another particularly preferred embodiment, the rhodium alloy comprises about 50 wt % rhodium. In another particularly preferred embodiment, the rhodium alloy comprises about 60 wt % rhodium. In another particularly preferred embodiment, the rhodium alloy comprises about 75 wt % rhodium. In another particularly preferred embodiment, the rhodium alloy comprises about 57.5 wt % rhodium. In another particularly preferred embodiment, the rhodium alloy comprises about 54.5 wt % rhodium. In another particularly preferred embodiment, the rhodium alloy comprises about 63.1 wt % rhodium.

In this embodiment, the rhodium alloy comprises at least one of iridium, platinum, palladium or ruthenium. The rhodium alloy may comprise up to about 25 wt % (e.g. about 0.01 to about 25 wt %) each of one or more elements selected from the consisting of iridium, platinum and palladium, preferably about 0.1 to about 20 wt % and more preferably about 1 to about 15 wt %. In one preferred embodiment, the rhodium alloy comprises about 0.01 to about 25 wt % of iridium, preferably about 0.1 to about 20 wt % and more preferably about 1 to about 15 wt %. In another preferred embodiment, the rhodium alloy comprises about 0.01 to about 25 wt % of platinum, preferably about 0.1 to about 20 wt % and more preferably about 1 to about 15 wt %. In yet another preferred embodiment, the rhodium alloy comprises about 0.01 to about 25 wt % of palladium, preferably about 0.1 to about 20 wt % and more preferably about 1 to about 15 wt %.

In one particularly preferred embodiment, the rhodium alloy may comprise about ≧0.1 wt % each of any one or more elements selected from the group consisting of iridium, platinum and palladium, for example about ≧0.5 wt %, such as about ≧0.6 wt % or about ≧0.7 wt %. In another preferred embodiment, the rhodium alloy may comprise about ≦20 wt % each of any one or more elements selected from the group consisting of iridium, platinum and palladium, for example about ≦15 wt %, such as about ≦10 wt %.

In one preferred embodiment, the rhodium alloy may comprise about 0.01 to about 35 wt % ruthenium, such as about 2.5 to about 33 wt %, for example about 5.0 to about 31 wt %. In one particularly preferred embodiment, the rhodium alloy comprises about 5 to about 10 wt % ruthenium, for example about 7.5 wt %. In another particularly preferred embodiment, the rhodium alloy comprises about 15 to about 25 wt % of ruthenium, such as about 20 wt % (e.g. 19.86 wt %). In yet another particularly preferred embodiment, the rhodium alloy comprises about 25 to about 35 wt % of ruthenium, such as about 30 wt % (e.g. 29.86 wt %).

In another preferred embodiment, the rhodium alloy may comprise no ruthenium i.e. 0 wt % ruthenium.

In one preferred embodiment, the rhodium alloy comprises about 5 to about 45 wt % of nickel. In one preferred embodiment, the rhodium alloy may comprise about ≧6 wt % of nickel, for example about ≧7 wt %, such as about ≧8 wt %, about ≧9 wt % or about ≧10 wt %. In another preferred embodiment, the rhodium alloy may comprise about ≦44 wt % of nickel, for example about ≦43 wt %, such as about ≦42 wt %. In one particularly preferred embodiment, the rhodium alloy comprises about 42 wt % of nickel. In another particularly preferred embodiment, the rhodium alloy comprises about 15.5 wt % of nickel. In yet another particularly preferred embodiment, the rhodium alloy comprises about 25 wt % of nickel. In another particularly preferred embodiment, the rhodium alloy comprises about 30 wt % of nickel. In yet another particularly preferred embodiment, the rhodium alloy comprises about 10 wt % of nickel. In yet another particularly preferred embodiment, the rhodium alloy comprises about 5 wt % of nickel. In yet another particularly preferred embodiment, the rhodium alloy comprises about 45 wt % of nickel. In yet another particularly preferred embodiment, the rhodium alloy comprises about 30 wt % of nickel. In yet another particularly preferred embodiment, the rhodium alloy comprises about 41.5 wt % of nickel. In yet another particularly preferred embodiment, the rhodium alloy comprises about 42 wt % of nickel.

In one preferred embodiment, the rhodium alloy may comprise about 0.01 to about 5 wt % of niobium. In another preferred embodiment, the rhodium alloy may comprise about 0.01 to about 5 wt % of tantalum. In yet another preferred embodiment, the rhodium alloy may comprise about 0.01 to about 5 wt % of titanium, such as about 0.5 to about 2.5 wt %, e.g. about 1 wt %. In another preferred embodiment, the rhodium alloy may comprise about 0.01 to about 5 wt % of chromium. In yet another preferred embodiment, the rhodium alloy may comprise about 0.01 to about 5 wt % of molybdenum. In another preferred embodiment, the rhodium alloy may comprise about 0.01 to about 5 wt % of cobalt. In yet another preferred embodiment, the rhodium alloy may comprise about 0.01 to about 5 wt % of rhenium. In another preferred embodiment, the rhodium alloy may comprise about 0.01 to about 5 wt % of vanadium. In yet another preferred embodiment, the rhodium alloy may comprise about 0.01 to about 5 wt % of aluminium. In another preferred embodiment, the rhodium alloy may comprise about 0.01 to about 5 wt % of hafnium. In yet another preferred embodiment, the rhodium alloy may comprise about 0.01 to about 5 wt % of tungsten. When the rhodium alloy comprises tungsten, the tungsten may be present in about 0.05 to about 2.5 wt %, such as about 0.06 to about 1.5 wt %, for example, about 0.07 to about 1 wt % e.g. about 0.1 to about 0.3 wt %.

In one preferred embodiment, the rhodium alloy may comprise about 0.01 to about 5 wt % each of any one or more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium and/or tungsten. The rhodium alloy may comprise about ≧0.025 wt % each of any one or more elements selected from the group consisting of niobium, tantalum, titanium, chromium, molybdenum, cobalt, rhenium, vanadium, aluminium, hafnium and tungsten, for example about ≧0.05 wt %, such as about ≧0.075 wt % or about ≧0.10 wt %. The rhodium alloy may comprise about ≦2.50 wt % each of any one or more elements selected from the group consisting of niobium, tantalum, titanium, chromium, molybdenum, cobalt, rhenium, vanadium, aluminium, hafnium and tungsten, for example about ≦2.00 wt %, such as about ≦1.50 wt % or about ≦1.00 wt %.

In one embodiment, the rhodium alloy does not comprise zirconium, yttrium or samarium.

In one preferred embodiment, the rhodium alloy may comprise about 0.01 to about 0.50 wt % of zirconium. In another preferred embodiment, the rhodium alloy may comprise about 0.01 to about 0.50 wt % of yttrium. In yet another preferred embodiment, the rhodium alloy may comprise about 0.01 to about 0.50 wt % of samarium.

In another preferred embodiment, the rhodium alloy may comprise about 0.02 to about 0.40 wt % each of any one or more elements selected from the group consisting of yttrium, zirconium and samarium. In another preferred embodiment, the rhodium alloy may comprise about ≧0.03 wt % each of any one or more elements selected from the group consisting of yttrium, zirconium and samarium, such as about ≧0.04 wt %. In yet another preferred embodiment, the rhodium alloy may comprise about ≦0.35 wt % each of any one or more elements selected from the group consisting of yttrium, zirconium and samarium, such as about ≦0.30 wt %.

Rhodium alloys according to the present invention may be selected from the group consisting of:

| | Rh | Ir | Ru | Ni | Mo | Cr | Ti | Al | W | Zr | Y |
|---|---|---|---|---|---|---|---|---|---|---|---|
| Alloy | (wt %) | (wt %) | (wt %) | (wt %) | (wt %) | (wt %) | (wt %) | (wt %) | (wt %) | (wt %) | (wt %) |
| A | 80 | 0 | 0 | 19.86 | 0 | 0 | 0 | 0 | 0.1 | 0.04 | 0 |
| B | 55 | 2.86 | 0 | 42 | 0 | 0 | 0 | 0 | 0.1 | 0.04 | 0 |
| C | 74 | 0.86 | 0 | 25 | 0 | 0 | 0 | 0 | 0.1 | 0.04 | 0 |
| D | 75 | 1.86 | 7.5 | 15.5 | 0 | 0 | 0 | 0 | 0.1 | 0.04 | 0 |
| E | 65 | 9.86 | 0 | 25 | 0 | 0 | 0 | 0 | 0.1 | 0.04 | 0 |
| F | 50 | 0 | 19.86 | 30 | 0 | 0 | 0 | 0 | 0.1 | 0.04 | 0 |
| G | 60 | 0 | 29.86 | 10 | 0 | 0 | 0 | 0 | 0.1 | 0.04 | 0 |
| H | 72.4 | 0 | 0 | 20 | 2.5 | 5 | 0 | 0 | 0 | 0 | 0.1 |
| I | 75 | 20 | 0 | 5 | 0 | 0 | 0 | 0 | 0 | 0 | 0 |
| J | 50 | 5 | 0 | 45 | 0 | 0 | 0 | 0 | 0 | 0 | 0 |
| K | 57.5 | 12.5 | 0 | 30 | 0 | 0 | 0 | 0 | 0 | 0 | 0 |
| L | 54.5 | 3 | 0 | 41.5 | 0 | 0 | 1 | 0 | 0 | 0 | 0 |
| M | 55 | 3 | 0 | 42 | 0 | 0 | 0 | 0 | 0 | 0 | 0 |
| N | 63.1 | 0 | 0 | 30.5 | 0 | 3.4 | 0 | 3 | 0 | 0 | 0 |

In certain embodiments, the rhodium alloy does not comprise Alloy D. In certain embodiments, the rhodium alloy does not comprise Alloy E. In certain embodiments, the rhodium alloy does not comprise Alloy F. In certain embodiments, the rhodium alloy does not comprise Alloy G.

The enhanced physical and mechanical properties of the rhodium alloys of the present invention make them suitable for use in high temperature or load bearing applications. As the alloys of the present invention demonstrate good resistance to erosion, the alloys may be used in ignition applications, e.g. as components in spark-plugs. The alloys may also be suitable for use as electrodes and some biomedical applications such as a stent. The alloys may also be suitable as pinning wire and lead-ins for sensors. The foregoing examples merely serve to illustrate the many potential uses of the present alloys and, as such, are not intended to be limiting in any way.

In another aspect, the invention provides the use of a rhodium alloy in an electrode or spark plug, wherein the rhodium alloy comprises:

i) rhodium; and

ii) nickel;

wherein the alloy comprises a greater quantity of rhodium as compared to any other individual element of the alloy.

The rhodium alloys are as generally described above.

In one embodiment, the rhodium alloy may be used in an electrode. In another embodiment, the rhodium alloy may be used in a spark plug.

In another aspect, the invention provides a rhodium alloy comprising:

i) rhodium;

ii) nickel; and

iii) one or more elements selected from the group consisting of yttrium, zirconium and samarium;

wherein the alloy comprises a greater quantity of rhodium as compared to any other individual element of the alloy.

The rhodium alloys are as generally described above.

The rhodium alloys may be manufactured by known methods and fabricated into any suitable form. Improvements in elongation to failure, or ductility, make the alloys particularly suitable for drawing into wires; however, the alloys may also be used to prepare tubes, sheets, grains, powders or other common forms. The alloys may also be used in spray coating applications.

Embodiments and/or optional features of the invention have been described above. Any aspect of the invention may be combined with any other aspect of the invention, unless the context demands otherwise. Any of the embodiments or optional features of any aspect may be combined, singly or in combination, with any aspect of the invention, unless the context demands otherwise.

The invention will now be described by way of the following non-limiting Examples and with reference to the following figures in which:

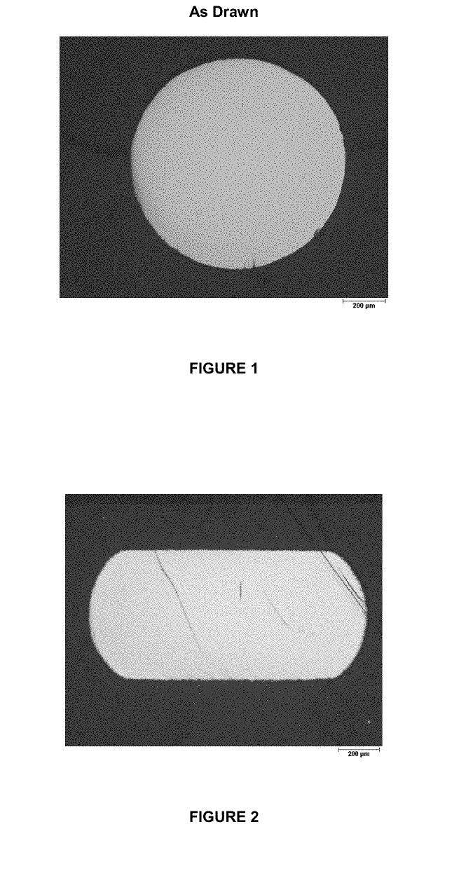

FIG. 1 illustrates a cross-section through a wire of a rhodium ally (Alloy B) as manufactured.

FIG. 2 illustrates a rhodium alloy (Alloy B) which has been annealed at 1100° C. for 15 minutes and then compressed in a die.

### EXAMPLES

### Example 1

### Alloy Preparation

The rhodium alloys detailed in Table 1 below are prepared by argon arc melting. All values are given in weight percent (wt %) based on the total weight of the alloy.

TABLE 1

| | Rh | Ir | Ru | Ni | Mo | Cr | Ti | Al | W | Zr | Y |
|---|---|---|---|---|---|---|---|---|---|---|---|
| Alloy | (wt %) | (wt %) | (wt %) | (wt %) | (wt %) | (wt %) | (wt %) | (wt %) | (wt %) | (wt %) | (wt %) |
| A | 80 | 0 | 0 | 19.86 | 0 | 0 | 0 | 0 | 0.1 | 0.04 | 0 |
| B | 55 | 2.86 | 0 | 42 | 0 | 0 | 0 | 0 | 0.1 | 0.04 | 0 |
| C | 74 | 0.86 | 0 | 25 | 0 | 0 | 0 | 0 | 0.1 | 0.04 | 0 |
| D | 75 | 1.86 | 7.5 | 15.5 | 0 | 0 | 0 | 0 | 0.1 | 0.04 | 0 |
| E | 65 | 9.86 | 0 | 25 | 0 | 0 | 0 | 0 | 0.1 | 0.04 | 0 |
| F | 50 | 0 | 19.86 | 30 | 0 | 0 | 0 | 0 | 0.1 | 0.04 | 0 |
| G | 60 | 0 | 29.86 | 10 | 0 | 0 | 0 | 0 | 0.1 | 0.04 | 0 |
| H | 72.4 | 0 | 0 | 20 | 2.5 | 5 | 0 | 0 | 0 | 0 | 0.1 |
| I | 75 | 20 | 0 | 5 | 0 | 0 | 0 | 0 | 0 | 0 | 0 |
| J | 50 | 5 | 0 | 45 | 0 | 0 | 0 | 0 | 0 | 0 | 0 |
| K | 57.5 | 12.5 | 0 | 30 | 0 | 0 | 0 | 0 | 0 | 0 | 0 |
| L | 54.5 | 3 | 0 | 41.5 | 0 | 0 | 1 | 0 | 0 | 0 | 0 |
| M | 55 | 3 | 0 | 42 | 0 | 0 | 0 | 0 | 0 | 0 | 0 |
| N | 63.1 | 0 | 0 | 30.5 | 0 | 3.4 | 0 | 3 | 0 | 0 | 0 |

Each alloy is subsequently processed to produce wire having a 1 mm or 2 mm diameter.

### Example 2

### Formability Testing

1. Wire at 1-2 mm diameter of Alloy B is cut into 50 mm lengths; actual diameter is noted. FIG. 1 illustrates a cross-section through the wire.
2. Wire samples are evaluated in the as-drawn and annealed condition to check whether formability is condition dependent. The wire samples are annealed at 1100° C. in air for 15 minutes.
3. Evaluation uses a bespoke die set encompassing rectangular cavities held in a fly press.
4. The wire samples are placed in the appropriate cavity and the press closed to force the sample into the cavity. The press is manually operated.
5. Following pressing the wire samples are examined visually, by microscope and ultimately by cross sectioning and metallographic preparation to allow measurement, determine the degree of deformation and check whether the integrity of the samples are preserved.
6. Assessment of the alloy's formability is based on the presence of any cracks, the relative size (length/width) of the cracks and the degree of deformation as calculated by the relative thickness of the deformed wire in comparison to the original diameter.

FIGS. 1 and 2 illustrate that the alloy demonstrates a high degree of deformability and remains substantially crack free.

### Example 3

### Electrode Studies

The rhodium alloys of the present invention, an iridium standard and a rhodium standard are cut into electrode wire having 1 mm diameter. The wires are fixed into a four station test cell together with matching 3 mm diameter Ir earth electrodes and the gap between them adjusted and set with a vernier calliper. The test electrodes are set at negative polarity and the earth electrode as positive to concentrate erosion on the appropriate electrodes.

Testing commences with a 10 kV electric pulse driven by an automotive ignition coil being applied to each pair of electrodes at 200 Hz. This initiates a continuous series of rapid spark discharges between the electrodes as generated in a typical automotive engine. The test cell is visually checked at intervals to confirm functionality and after approximately 250 hr. the discharge is stopped and the electrode gap re-measured. A counter initiated at test commencement is used to measure elapsed time from which the number of spark discharges can be calculated.

The electrodes are reset in the test cell and discharge re-initiated. After a further approximately 250 hr. (approx. 500 hrs discharge time in total) the test is stopped and the same procedure of gap measurement and electrode inspection completed.

Test Duration

The test duration and approximate number of sparks were calculated. Therefore, for a 20 day test:
20 days×24 hrs/day=480 hrs
480 hrs×3600 seconds/hr=1,728,000 seconds
1,728,000 seconds×200 sparks/second=345,600,000 sparks (per test point)

Measurements of Gaps

| Test gap - | Startpoint | Midpoint | | |
|---|---|---|---|---|
| negative | Gap | Gap | Endpoint Gap | Gap Growth |
| electrode | (mm) | (mm) | (mm) | (mm) |
| 100% Ir | 8.2 | 8.6 | 8.9 | 0.7 |
| (comparative) | | | | |
| 100% Rh | 8.1 | 8.2 | 8.4 | 0.3 |
| (comparative) | | | | |
| Alloy A | 8.1 | 8.2 | 8.3 | 0.2 |
| Alloy B | 8.1 | 8.1 | 8.2 | 0.1 |
| Alloy H | 8.1 | 8.0 | 8.3 | 0.2 |
| Alloy I | 7.9 | 7.9 | 8.0 | 0.1 |
| Alloy J | 8.0 | 8.1 | 8.2 | 0.2 |
| Alloy K | 8.0 | 8.1 | 8.2 | 0.2 |
| Alloy L | 8.0 | 8.1 | 8.2 | 0.3 |
| Alloy M | 7.9 | 8.1 | 8.2 | 0.3 |

The 100% Ir electrode exhibits the worst (most) erosion, the gap measurement changing by 0.7 mm+/−0.1 mm over the test duration.

The 100% Rh, and Alloy A, B and H-M electrodes exhibit less erosion than the 100% Ir electrode. The Alloy L and M electrodes exhibit comparable erosion resistance to the 100% Rh electrode over the test duration. The Alloy A, H, J and K electrodes exhibit better erosion resistance than the 100% Rh electrode as the gap measurements change by 0.2 mm+/−0.1 mm in comparison to 0.3 mm+/−0.1 mm for the 100% rhodium electrode over the test duration. Alloys B and I also exhibit better erosion resistance than the 100% Rh electrode as the gap measurements change by 0.1 mm+/−0.1 mm in comparison to 0.3 mm+/−0.1 mm for the 100% rhodium electrode over the test duration.

1-18. (canceled)

19. An electrode comprising a rhodium alloy, wherein the rhodium alloy comprises:
i) rhodium; and
ii) 5 to 45 wt % of nickel;
wherein the alloy comprises a greater quantity of rhodium as compared to any other individual element of the alloy.

20. An electrode according to claim 19, wherein the rhodium alloy further comprises:
iii) one or more elements selected from the group consisting of yttrium, zirconium and samarium.

21. An electrode according to claim 19, wherein the rhodium alloy comprises:
a) about 50 wt % or more of rhodium;
b) up to about 49.99 wt % each of any one or more elements selected from the group consisting of iridium, platinum and palladium;
c) up to about 35 wt % of ruthenium;
d) about 0.01 to about 49.99 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
wherein the total wt % of the rhodium alloy adds up to 100 wt %.

22. An electrode according to claim 19, wherein the rhodium alloy comprises:
a) about 75 wt % or more of rhodium;
b) 0 wt % each of any one or more elements selected from the group consisting of iridium, platinum and palladium;
c) 0 wt % of ruthenium;
d) about 0.01 to about 25 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
wherein the total wt % of the rhodium alloy adds up to 100 wt %.

23. An electrode according to claim 19, wherein the rhodium alloy comprises:
a) about 50 to about 95 wt % or more of rhodium;
b) up to about 25 wt % each of any one or more elements selected from the group consisting of iridium, platinum and palladium;
c) up to about 35 wt % of ruthenium;
d) about 0.01 to about 49.99 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
wherein the rhodium alloy comprises at least one of iridium, platinum, palladium or ruthenium; and
wherein the total wt % of the rhodium alloy adds up to 100 wt %.

24. An electrode according to claim 19, wherein the rhodium alloy is selected from the group consisting of:

| | Rh | Ir | Ru | Ni | Mo | Cr | Ti | Al | W | Zr | Y |
|---|---|---|---|---|---|---|---|---|---|---|---|
| Alloy | (wt %) | (wt %) | (wt %) | (wt %) | (wt %) | (wt %) | (wt %) | (wt %) | (wt %) | (wt %) | (wt %) |
| A | 80 | 0 | 0 | 19.86 | 0 | 0 | 0 | 0 | 0.1 | 0.04 | 0 |
| B | 55 | 2.86 | 0 | 42 | 0 | 0 | 0 | 0 | 0.1 | 0.04 | 0 |
| C | 74 | 0.86 | 0 | 25 | 0 | 0 | 0 | 0 | 0.1 | 0.04 | 0 |
| D | 75 | 1.86 | 7.5 | 15.5 | 0 | 0 | 0 | 0 | 0.1 | 0.04 | 0 |
| E | 65 | 9.86 | 0 | 25 | 0 | 0 | 0 | 0 | 0.1 | 0.04 | 0 |
| F | 50 | 0 | 19.86 | 30 | 0 | 0 | 0 | 0 | 0.1 | 0.04 | 0 |
| G | 60 | 0 | 29.86 | 10 | 0 | 0 | 0 | 0 | 0.1 | 0.04 | 0 |
| H | 72.4 | 0 | 0 | 20 | 2.5 | 5 | 0 | 0 | 0 | 0 | 0.1 |
| I | 75 | 20 | 0 | 5 | 0 | 0 | 0 | 0 | 0 | 0 | 0 |
| J | 50 | 5 | 0 | 45 | 0 | 0 | 0 | 0 | 0 | 0 | 0 |
| K | 57.5 | 12.5 | 0 | 30 | 0 | 0 | 0 | 0 | 0 | 0 | 0 |
| L | 54.5 | 3 | 0 | 41.5 | 0 | 0 | 1 | 0 | 0 | 0 | 0 |
| M | 55 | 3 | 0 | 42 | 0 | 0 | 0 | 0 | 0 | 0 | 0 |
| N | 63.1 | 0 | 0 | 30.5 | 0 | 3.4 | 0 | 3 | 0 | 0 | 0 |

25. A spark plug comprising an electrode according to claim 19.

26. A rhodium alloy comprising:
i) rhodium;
ii) nickel; and
iii) one or more elements selected from the group consisting of yttrium, zirconium and samarium;
wherein the alloy comprises a greater quantity of rhodium as compared to any other individual element of the alloy.

27. A rhodium alloy according to claim 31, wherein the alloy comprises about 5 to about 45 wt % of nickel.

28. A rhodium alloy according to claim 31, wherein the alloy comprises:
a) about 50 wt % or more of rhodium;
b) up to about 49.99 wt % each of any one or more elements selected from the group consisting of iridium, platinum and palladium;
c) up to about 35 wt % of ruthenium;
d) about 0.01 to about 49.99 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
f) about 0.01 to about 1.00 wt % each of any one or more elements selected from the group consisting of yttrium, zirconium and samarium; and
wherein the total wt % of the rhodium alloy adds up to 100 wt %.17.
A rhodium alloy according to claim 31 the alloy comprises:
a) about 75 wt % or more of rhodium;
b) 0 wt % each of any one or more elements selected from the group consisting of iridium, platinum and palladium;
c) 0 wt % of ruthenium;
d) about 0.01 to about 25 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
f) about 0.01 to about 1.00 wt % each of any one or more elements selected from the group consisting of yttrium, zirconium and samarium; and
wherein the total wt % of the rhodium alloy adds up to 100 wt %.

29. A rhodium alloy according to claim 31, wherein the alloy comprises:
a) about 50 to about 95 wt % or more of rhodium;
b) up to about 25 wt % each of any one or more elements selected from the group consisting of iridium, platinum and palladium;
c) up to about 35 wt % of ruthenium;
d) about 0.01 to about 49.99 wt % of nickel;
e) up to about 5 wt % each of any one of more elements selected from the group consisting of niobium, tantalum, titanium, chromium, molybdenum, cobalt, rhenium, vanadium, aluminium, hafnium and tungsten; and
f) about 0.01 to about 0.50 wt % each of any one or more elements selected from the group consisting of yttrium, zirconium and samarium;
wherein the rhodium alloy comprises at least one of iridium, platinum, palladium or ruthenium; and
wherein the total wt % of the rhodium alloy adds up to 100 wt %.

30. A rhodium alloy according to claim 31, wherein the alloy is selected from the group consisting of:

| | Rh | Ir | Ru | Ni | Mo | Cr | Ti | Al | W | Zr | Y |
|---|---|---|---|---|---|---|---|---|---|---|---|
| Alloy | (wt %) | (wt %) | (wt %) | (wt %) | (wt %) | (wt %) | (wt %) | (wt %) | (wt %) | (wt %) | (wt %) |
| A | 80 | 0 | 0 | 19.86 | 0 | 0 | 0 | 0 | 0.1 | 0.04 | 0 |
| B | 55 | 2.86 | 0 | 42 | 0 | 0 | 0 | 0 | 0.1 | 0.04 | 0 |
| C | 74 | 0.86 | 0 | 25 | 0 | 0 | 0 | 0 | 0.1 | 0.04 | 0 |
| D | 75 | 1.86 | 7.5 | 15.5 | 0 | 0 | 0 | 0 | 0.1 | 0.04 | 0 |
| E | 65 | 9.86 | 0 | 25 | 0 | 0 | 0 | 0 | 0.1 | 0.04 | 0 |
| F | 50 | 0 | 19.86 | 30 | 0 | 0 | 0 | 0 | 0.1 | 0.04 | 0 |
| G | 60 | 0 | 29.86 | 10 | 0 | 0 | 0 | 0 | 0.1 | 0.04 | 0 |
| H | 72.4 | 0 | 0 | 20 | 2.5 | 5 | 0 | 0 | 0 | 0 | 0.1 |
| I | 75 | 20 | 0 | 5 | 0 | 0 | 0 | 0 | 0 | 0 | 0 |
| J | 50 | 5 | 0 | 45 | 0 | 0 | 0 | 0 | 0 | 0 | 0 |
| K | 57.5 | 12.5 | 0 | 30 | 0 | 0 | 0 | 0 | 0 | 0 | 0 |
| L | 54.5 | 3 | 0 | 41.5 | 0 | 0 | 1 | 0 | 0 | 0 | 0 |
| M | 55 | 3 | 0 | 42 | 0 | 0 | 0 | 0 | 0 | 0 | 0 |
| N | 63.1 | 0 | 0 | 30.5 | 0 | 3.4 | 0 | 3 | 0 | 0 | 0 |

31. The electrode of claim 21, wherein the rhodium alloy further comprises about 0.01 to about 1.00 wt % each of any one or more elements selected from the group consisting of yttrium, zirconium and samarium.

32. The electrode of claim 22, wherein the rhodium alloy further comprises about 0.01 to about 1.00 wt % each of any one or more elements selected from the group consisting of yttrium, zirconium and samarium.

33. The electrode of claim 23, wherein the rhodium alloy further comprises about 0.01 to about 0.50 wt % each of any one or more elements selected from the group consisting of yttrium, zirconium and samarium.

34. A spark plug comprising an electrode according to claim 20.

35. A spark plug comprising an electrode according to claim 21.

36. A spark plug comprising an electrode according to claim 22.

37. A spark plug comprising an electrode according to claim 23.

38. A spark plug comprising an electrode according to claim 24.
